(19) United States
(12) Patent Application Publication
(10) Pub. No.: US 2004/0196750 A1
(43) Pub. Date: Oct. 7, 2004

(54) Method of braking control in rapid track seeking for an optical drive

(76) Inventors: Jen-Yu Hsu, Taipei (TW); Hsiang-Yi Fu, Taipei (TW); Tun-Chieh Lee, Taipei (TW); Fu-Hsiang Chen, Taipei (TW); Yao-Chou Tsai, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/814,030

(22) Filed: Mar. 31, 2004

(30) Foreign Application Priority Data
Apr. 2, 2003 (TW) 92107468

(51) Int. Cl. G11B 7/085

(52) U.S. Cl. 369/30.16; 369/30.15; 369/44.28

(57) ABSTRACT

A method of braking control in rapid track seeking for an optical drive. The optical drive has a pickup head for reading information from an optical disc therein. According to the method, a tracking error signal is obtained in the rapid track seeking motion of the pickup head. A seeking velocity is obtained by calculation according to the tracking error signal. Since the seeking velocity varies, a braking force is determined according to the seeking velocity for braking the pickup head.

### BACKGROUND OF THE INVENTION

1. Field of the Invention

The present invention relates to a method of braking control in rapid track seeking for an optical drive. Particularly, the present invention relates to a method of braking control for an optical drive, in which a braking force is modulated according to the seeking velocity of the pickup head of the optical drive.

2. Description of the Related Art

An optical storage device can be either a device or system that is capable of retrieving information stored on an optical disc, or a device or system capable of recording information to and retrieving information from an optical disc. Examples of optical disc storage devices capable of retrieving information from an optical disc include compact disc (CD) players, laser disc (LD) players, and compact disc read-only-memory (CD-ROM) drives. Examples of optical disc storage devices capable of both recording information to an optical disc and retrieving information from an optical disc include recordable mini-disc (MD) players, magneto-optical (MO) optical drives and compact disc recordable (CD-R) drives.

Generally, information is stored on an optical disc in the form of concentric or spiral tracks referred to as information tracks. In cases where information is already stored on an optical disc, the information tracks contain regions of different optical contrasts that represent the associated stored information.

When an optical storage device is in its normal mode of operation, i.e. retrieving information from or recording information to an optical disc, the optical storage device rotates the optical disc while using a light beam emitted from a pickup head to retrieve information from or record information to the optical disc. As the optical disc rotates, the pickup head radially traverses the optical disc along a specific track (an information track in the case of retrieving information from the optical disc, or a track that will become the information track in the case of recording information to the optical disc). This motion of the pickup head and its direction are respectively referred to as track following and track direction. Practically, a track seeking motion is performed prior to the track following so that the pickup head moves to locate the specific track on the optical disc.

When the pickup head traverses the optical disc, a tracking servo system in the optical disc storage device keeps the beam of light emitted from the pickup head in the center of the specific track. The tracking servo system is a closed loop system that guides the pickup head to follow the specific track during normal operation. The tracking servo system readjusts the radial position of the pickup head by sensing when the pickup head or the light beam drifts off the center of the specific track.

FIG. 1 is a cross-sectional diagram showing the pickup head and spindle of an optical disc storage device, e.g. an optical drive. An optical disc 11 in the optical drive has a concentric or spiral information track 111 and is disposed on a spindle 12 which rotates the optical disc 11. A pickup head 13 has a lens 131 and a fine actuator 132 which drives a fine tracking motion of the lens 131. When a light beam (not shown) emitted from the lens 131 cannot be centered on the information track 111 only with the fine actuator 132, a coarse actuator 14 drives a tracking motion of the pickup head 13 assistant to the fine actuator 132.

FIG. 2 is a block diagram showing a conventional tracking servo system applied in the above described optical drive. The same elements in FIG. 1 and FIG. 2 are referred to by the same numerals. The tracking servo system 2 is a closed loop which comprises a fine controller 211, a fine driver 212, a fine actuator 132, a coarse controller 221, a coarse driver 222, a coarse actuator 14, an optical sensor 23, and a pre-amplifier (AMP) 24.

The optical sensor 23 senses a deviation between the pickup head 13 and the center of the information track 111 and notes the deviation with a tracking error signal TES. The tracking error signal TES is amplified by the pre-amplifier 24 and sent to the fine controller 211. The fine controller 211 receives the amplified tracking error signal TES and generates a fine correction which is proportional to the deviation. The fine correction is sent with a fine correction signal FCS to the fine driver 212. The fine driver 212 receives the signal FCS and sends a fine driving signal FDS to the fine actuator 132, which accordingly generates a force to drive the pickup head 13. The magnitude of the fine driving force is also linearly proportionate to the value of the fine correction according to the signal FCS.

Further, the coarse controller 221 receives the signal FCS sent by the fine controller 211. With a sampling rate lower than that of the fine controller 211, the coarse controller 221 acts like a low-pass-filter for the signal FCS and generates a coarse correction when there is significant deviation. The coarse correction is sent with a coarse correction signal CCS to the coarse driver 222. After receiving the signal CCS, the coarse driver 222 sends a coarse driving signal, CDS to the coarse actuator 14, which accordingly generates a force to drive the pickup head 13. The magnitude of the coarse driving force is also linearly proportionate to the value of the coarse correction according to the signal CCS.

In the track seeking motion, the pickup head 13 performs a braking process when the pickup head 13 moves closer to the center of the specific track. In a conventional braking process, the coarse controller 221 sends a fixed coarse driving signal CDS to the coarse actuator 14, which accordingly generates a force as a braking force for a certain period of time to reduce the seeking velocity of the pickup head 13. Thus, after the braking process, the pickup head 13 moves close enough to the specific track for the fine actuator 132 to drive the pickup head 13.

The above-mentioned braking process, however, only controls braking by force for a certain period of time. When the braking process is performed, the magnitude of the coarse driving force is linearly proportionate to the value of the coarse correction; that is, the seeking velocity of the pickup head 13 is not fixed. Accordingly, if the pickup head 13 moves too fast, the braking force may be relatively small so that the pickup head 13 moves beyond the center of the specific track. Conversely, if the pickup head 13 moves too slow, the braking force may be relatively large so that the pickup head 13 jitters or even stops before moving close enough to the center of the specific track. Thus, the seeking velocity of the pickup head 13 is limited in a range by the fixed braking force.

### SUMMARY OF THE INVENTION

Accordingly, an object of the present invention is to provide a method of braking control for an optical drive, which enables the braking force of the pickup head to vary according to the seeking velocity of the pickup head.

Another object of the present invention is to provide a method of braking control for an optical drive, which enables the track seeking motion to be performed at a relatively high speed. Thus, optimal rapid track seeking for the optical drive can be achieved.

The present invention discloses a method of braking control in rapid track seeking for an optical drive, which has a pickup head for reading information from an optical disc therein. According to the method, in the rapid track seeking motion of the pickup head, a deviation between the pickup head and a center of an information track on the optical disc is detected, and a tracking error signal is obtained according to the deviation. Thus, a seeking velocity can be obtained by calculation according to the tracking error signal. Since the seeking velocity varies, a braking force is determined, e.g. selected from a plurality of predetermined braking forces, according to the seeking velocity to slow the pickup head. Alternatively, the seeking velocity and a related braking force can be obtained by calculation according to the tracking error signal.

In an embodiment of the present invention, a predetermined distance D is provided so that the step of obtaining the tracking error signal is not performed until the deviation is no greater than the predetermined distance D.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-sectional diagram of the pickup head and spindle mechanism of an optical drive;

FIG. 2 is a block diagram of a conventional tracking servo system in the optical drive;

FIG. 3 is a flow chart of an embodiment of the method of braking control in rapid track seeking for an optical drive of the present invention;

FIG. 4 is a flow chart of another embodiment of the method of braking control in rapid track seeking for an optical drive of the present invention; and

FIGS. 5 and 6 are diagrams showing experimental results for the relationship between the tracking error signal and the braking force according to the method in FIG. 3.

### DETAILED DESCRIPTION OF THE INVENTION

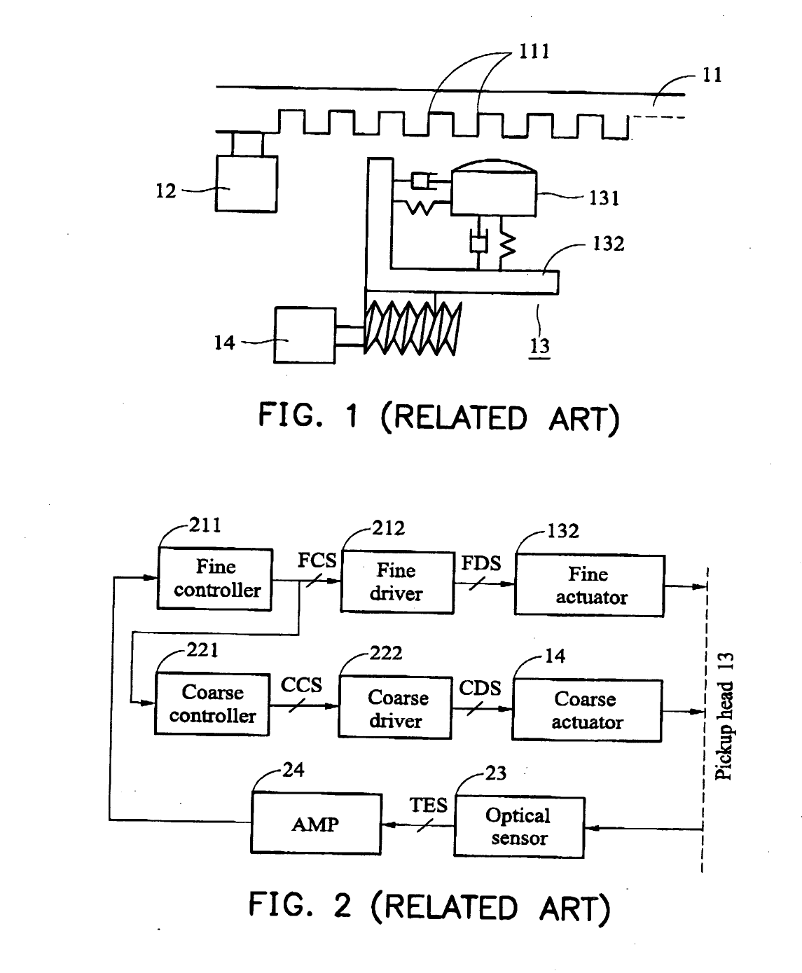

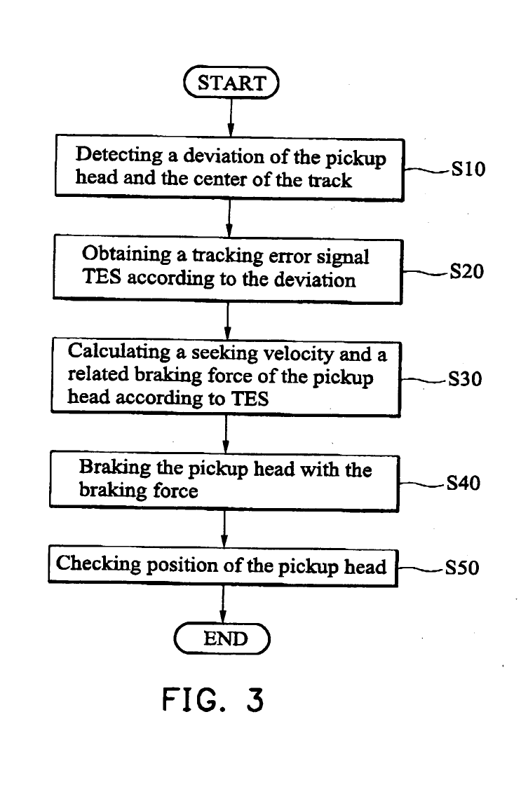

Disclosed hereinafter is a method of braking control in rapid track seeking for an optical drive. A typical optical drive, e.g. one with the mechanism shown in FIG. 1 and the tracking servo system in FIG. 2, can be used to implement or facilitate description of the method with reference to the figures. Although this method is described in detail, it will be appreciated that this method is provided for purposes of illustration only and that various modifications are feasible without departing from the inventive concept.

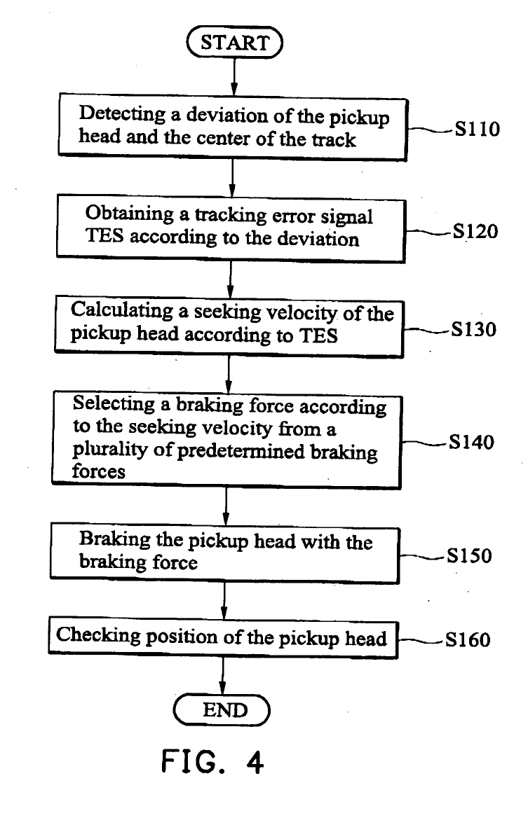

The present invention discloses a method of braking control in rapid track seeking for an optical drive. Practically, the method can be applied to the coarse actuator of a conventional tracking servo system in FIG. 2. An embodiment of the method of the present invention is shown in the flow chart of FIG. 3.

In the rapid track seeking motion of the pickup head, a deviation between the pickup head and a center of an information track on the optical disc is detected (step S10) by the optical sensor 23, and a tracking error signal TES is obtained according to the deviation (step S20). The tracking error signal TES can be a sine wave signal.

Then, a seeking velocity and a related braking force can be obtained by calculation according to the tracking error signal TES (step S30). In this case, when the seeking velocity is large, a large braking force can be selected; otherwise, a small braking force can be applied when the pickup head is moving slowly.

When the braking force is determined or selected, the coarse actuator 14 provides the braking force to the pickup head 13 to perform braking (step S40). Then, a checking process of the pickup head 13 is performed (step 50) to determine if the position of the pickup head 13 is close enough to the center of the information track. When the pickup head 13 moves close enough to the center of the information track, the coarse actuator 14 stops driving the track seeking motion, and the pickup head 13 is driven by the track-following motion only. Otherwise, the track seeking motion continues, and the steps S10 to S40 are performed again.

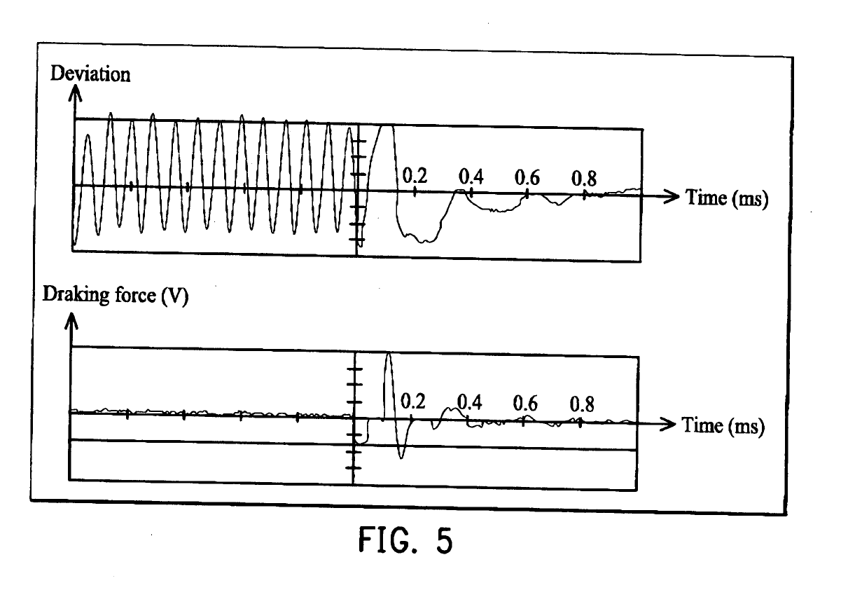

Another embodiment of the method of the present invention is shown in the flow chart of FIG. 4. In the rapid track seeking motion of the pickup head, a deviation between the pickup head and a center of an information track on the optical disc is detected (step S110) by the optical sensor 23, and a tracking error signal TES is obtained according to the deviation (step S120). The tracking error signal TES can be a sine wave signal.

Then, a seeking velocity can be obtained by calculation according to the tracking error signal TES (step S130). Since the seeking velocity varies, a braking force is determined, e.g. selected from a plurality of predetermined braking forces, by the coarse actuator 14 according to the seeking velocity for braking the pickup head (step S140). A look-up table associated with the seeking velocity and the corresponding braking force is built for convenience of implement. In this case, when the seeking velocity is large, a large braking force can be selected; otherwise, a small braking force can be applied when the pickup head is moving slowly.

When the braking force is determined or selected, the coarse actuator 14 provides the braking force to the pickup head 13 to perform braking (step S150) Then, a checking process of the pickup head 13 is performed (step S160) to determine if the position of the pickup head 13 is close enough to the center of the information track. When the pickup head 13 moves close enough to the center of the information track, the coarse actuator 14 stops driving the track seeking motion, and the pickup head 13 is driven by the track-following motion only. Otherwise, the track seeking motion continues, and the steps S110 to S150 are performed again.

According to the above-mentioned method of the present invention, the braking force is determined according to the seeking velocity of the pickup head 13. Accordingly, the track seeking motion can be performed rapidly, which enhances operational efficiency of the optical drive.

It should be mentioned that, in the track seeking motion, the braking process should be activated when the deviation between the pickup head 13 and the center of the information track is too large. Specifically, when the pickup head 13 is far from the center of the information track, it is unnecessary to activate the braking process. Accordingly, it is preferred for the method of the present invention to provide a predetermined distance D as a threshold of the deviation. In this case, when the deviation is larger than the predetermined distance D, the steps S20 to S50 are not performed, so the pickup head 13 moves to the center of the information track without braking until the deviation is no larger than the predetermined distance.

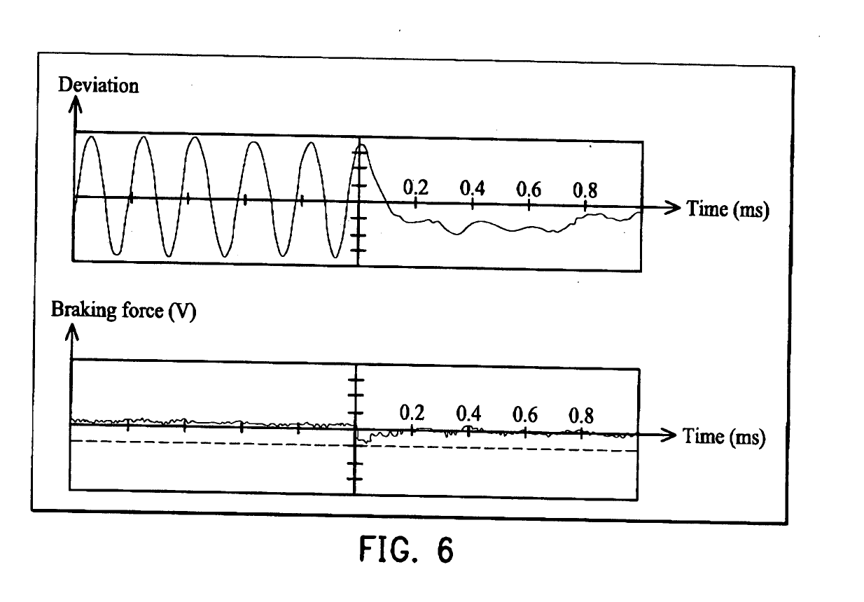

FIG. 4 and FIG. 5 are diagrams showing experimental results for the relationship between the tracking error signal TES and the braking force according to the method in FIG. 3. It is shown that in both FIG. 4 and FIG. 5 the tracking error signal TES is a continuous sine wave signal, and each cycle of the sine wave signal of the tracking error signal TES indicates a cross of an information track. When the frequency of the tracking error signal TES is increased, i.e. the wave shape is tightened, the seeking velocity is increased. Further, a predetermined distance is provided, which is represented by the origin of the coordinates in the diagrams.

In FIG. 4, frequency of the tracking error signal TES is approximately 12.5 Hz. With the method of the present invention, the braking force calculated in the origin of the coordinates in FIG. 4 is a pulse with a magnitude of −0.32V, in which the negative value indicates that the braking force has a reverse direction to the moving direction of the pickup head. Meanwhile, the frequency of the tracking error signal, TES, in FIG. 5 is approximately 5.15 Hz; that is, the seeking velocity in FIG. 5 is slower than that in FIG. 4. With the method of the present invention, the braking force calculated in the origin of the coordinates in FIG. 5 is a pulse with a magnitude of −0.19V. Accordingly, the braking force varies according to the seeking velocity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of braking control in rapid track seeking for an optical drive, comprising the steps of:
detecting a deviation between a pickup head of the optical drive and a center of an information track on an optical disc in the optical drive;
obtaining a tracking error signal according to the deviation;
a calculating a seeking velocity according to the tracking error signal;
determining a braking force for the pickup head according to the seeking velocity; and
braking the pickup head with the braking force.

2. The method of braking control in rapid track seeking for an optical drive as claimed in claim 1, further comprising:
providing a predetermined distance so that the step of obtaining the tracking error signal is not performed until the deviation is no greater than the predetermined distance.

3. The method of braking control in rapid track seeking for an optical drive as claimed in claim 1, wherein the tracking error signal is a sine wave signal.

4. The method of braking control in rapid track seeking for an optical drive as claimed in claim 1, wherein the optical drive further comprises a coarse actuator for providing the braking force.

5. The method of braking control in rapid track seeking for an optical drive as claimed in claim 1, wherein the optical drive further comprises an optical sensor for detecting the deviation and obtaining the tracking error signal.

6. A method of braking control in rapid track seeking for an optical drive, comprising the steps of:
calculating a seeking velocity of a pickup head of the optical drive according to a tracking error signal of the pickup head; and
selecting a braking force from a plurality of predetermined braking forces according to the seeking velocity, and braking the pickup head with the braking force.

7. The method of braking control in rapid track seeking for an optical drive as claimed in claim 6, wherein the tracking error signal is a sine wave signal.

8. The method of braking control in rapid track seeking for an optical drive as claimed in claim 6, wherein the optical drive further comprises a coarse actuator for providing the braking force.

9. The method of braking control in rapid track seeking for an optical drive as claimed in claim 6, wherein the optical drive further comprises an optical sensor for detecting a deviation between the pickup head and a center of an information track on an optical disc in the optical drive and obtaining the tracking error signal.

10. A method of braking control in rapid track seeking for an optical drive, comprising the steps of:
calculating a seeking velocity of a pickup head of the optical drive and a related braking force according to a tracking error signal of the pickup head; and
applying the braking force according to the seeking velocity to the pickup head.

11. The method of braking control in rapid track seeking for an optical drive as claimed in claim 10, wherein the tracking error signal is a sine wave signal.

12. The method of braking control in rapid track seeking for an optical drive as claimed in claim 10, wherein the optical drive further comprises a coarse actuator for providing the braking force.

13. The method of braking control in rapid track seeking for an optical drive as claimed in claim 10, wherein the optical drive further comprises an optical sensor for detecting a deviation between the pickup head and a center of an information track on an optical disc in the optical drive and obtaining the tracking error signal.
